(19) United States
(12) Patent Application Publication
(10) Pub. No.: US 2004/0196996 A1
(43) Pub. Date: Oct. 7, 2004

(54) Hearing aid and hearing aid accessory cosmetic and functional cover

(76) Inventor: Mark A. Feitel, Plymouth, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/407,973

(22) Filed: Apr. 2, 2003

(51) Int. Cl. H04R 25/00

(52) U.S. Cl. 381/322; 381/330

(57) ABSTRACT

The present method and structure provides a cover for a behind-the-ear hearing aid. The cover includes a shell formed from a rigid material where the shell is adapted for a removable shaped fit over at least a portion of the behind-the-ear hearing aid.

### FIELD OF THE INVENTION

This application relates generally to a method and apparatus used in connection with a hearing device, and more particularly to a method and apparatus for applying a cover to a hearing device.

### BACKGROUND

Devices that aid in the hearing process are costly, delicate and sensitive pieces of equipment. Internal and external components of hearing devices are susceptible to malfunction or breakage from factors both in and out of the control of the user's environment. Used daily, hearing devices do not function properly when damaged by soil, moisture, contaminants and when dropped on a hard surface.

Current solutions include submerging the hearing device into a liquid plastic to form a seal and placing the hearing device into a container with a silica gel. Another solution places a latex covering over the hearing device. These solutions can obstruct the operation of the various components of the hearing device.

An additional problem arises when children bump or fiddle with the external controls of the hearing device causing the device not to perform in the intended manner.

Current hearing devices are also susceptible to Radio Frequency Interference (RFI) and Electromagnetic Interference (EMI) from every day devices used in our environment.

Accordingly, what is needed is an improved hearing device that is resistant to soil, moisture, contaminants and is resistant to marring caused by dropping or misuse.

### SUMMARY

The various embodiments described herein relate to method and apparatus for applying a cover to a hearing device. The teachings provided herein solve the earlier mentioned problems and other problems not stated herein.

The present structure and method provides a cover for a behind-the-ear (BTE) hearing aid that is resistant to soil, moisture, contaminants and is resistant to marring caused by dropping or misuse. In another embodiment, the present structure and method further provides a cover for a BTE hearing aid that improves the audio quality of the hearing aid by reducing, eliminating or channeling RF energy, EM energy, or both and which is aesthetically pleasing to the user.

In one aspect, the present structure and method provides a cover for a BTE hearing aid. The cover for the BTE includes a shell formed from a rigid material where the shell is adapted for a removable shaped fit over at least a portion of the BTE hearing aid.

In another aspect, the present structure and method provides a method of manufacturing a cover for a BTE hearing aid. The method includes forming a shell having a rigid material where the shell is adapted for a removable shaped fit over at least a portion of the BTE hearing aid.

In yet another aspect, the present structure and method provides a method of using a cover for a BTE hearing aid. The method includes holding a shell formed from a rigid material where the shell is adapted for a removable shaped fit over at least a portion of the BTE hearing aid, applying the shell adapted for a removable shaped fit over the at least portion of the BTE hearing aid and affixing at least a portion of the BTE hearing aid and the shell about an ear.

This Summary is an overview of some of the teachings of the present application and not intended to be an exclusive or exhaustive treatment of the present subject matter. Further details about the present subject matter are found in the detailed description and appended claims. Other aspects of the invention will be apparent to persons skilled in the art upon reading and understanding the following detailed description and viewing the drawings that form a part thereof, each of which are not to be taken in a limiting sense. The scope of the present invention is defined by the appended claims and their equivalents. Various embodiments are illustrated by way of example and not by way of limitation in the figures of the accompanying drawings in which like references indicate similar elements.

### DESCRIPTION OF THE DRAWINGS

FIG. 1 illustrates a perspective view of a shell and BTE hearing aid in accordance with one embodiment of the invention.

FIG. 2 illustrates a side view of a shell and BTE hearing aid in accordance with one embodiment of the invention.

FIG. 3 illustrates a perspective view of a shell and BTE hearing aid in accordance with one embodiment of the invention.

FIG. 4 illustrates a perspective view of a shell and BTE hearing aid in accordance with one embodiment of the invention.

FIG. 5 illustrates a perspective view of a shell and BTE hearing aid in accordance with one embodiment of the invention.

FIG. 6 illustrates a perspective view of a shell and BTE hearing aid in accordance with one embodiment of the invention.

FIG. 7 illustrates a perspective view of a shell and BTE hearing aid in accordance with one embodiment of the invention.

FIG. 8 illustrates a side view of a shell and BTE hearing aid in accordance with one embodiment of the invention.

FIG. 9 illustrates a perspective view of a shell and BTE hearing aid in accordance with one embodiment of the invention.

FIG. 10 illustrates a perspective view of a shell and BTE hearing aid in accordance with one embodiment of the invention.

FIG. 11 illustrates a perspective view of a shell and BTE hearing aid in accordance with one embodiment of the invention.

FIG. 12 illustrates a front view of a shell and BTE hearing aid in accordance with one embodiment of the invention.

FIG. 13 illustrates a front view of a shell and BTE hearing aid in accordance with one embodiment of the invention.

FIG. 14 illustrates a side view of a shell and BTE hearing aid in accordance with one embodiment of the invention.

FIG. 15 illustrates a side view of a shell and BTE hearing aid in accordance with one embodiment of the invention.

FIG. 16 illustrates a side view of a shell and BTE hearing aid in accordance with one embodiment of the invention.

FIG. 17 illustrates a side view of a shell and BTE hearing aid in accordance with one embodiment of the invention.

FIG. 18 illustrates a side view of a shell and BTE hearing aid in accordance with one embodiment of the invention.

FIG. 19 illustrates a side view of a shell and BTE hearing aid in accordance with one embodiment of the invention.

FIG. 20 illustrates a perspective view of multiple shells in accordance with one embodiment of the invention.

### DETAILED DESCRIPTION

In the following description, for purposes of explanation, numerous specific details are set forth in order to provide a thorough understanding of the various embodiments. It will be apparent, however, to one skilled in the art that the various embodiments may be practiced without some of these specific details. The following description and drawings provide examples for illustration, but are not intended in a limiting sense and are not intended to provide an exhaustive treatment of all possible implementations.

It should be noted that references to “an”, “one”, or “various” embodiments in this disclosure are not necessarily to the same embodiment, and such references contemplate more than one embodiment.

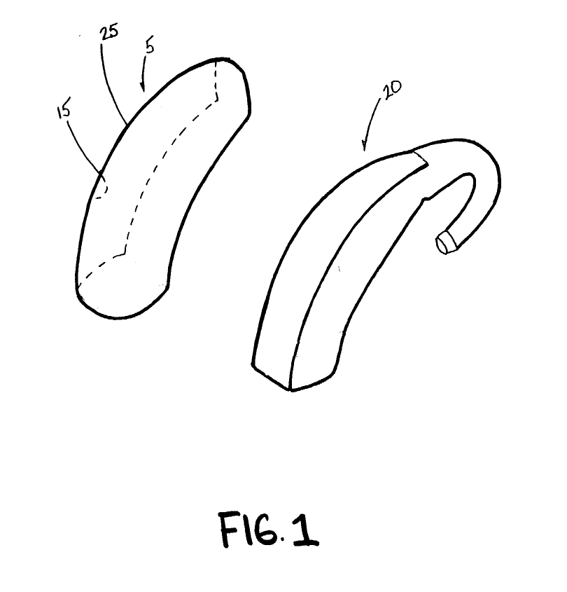

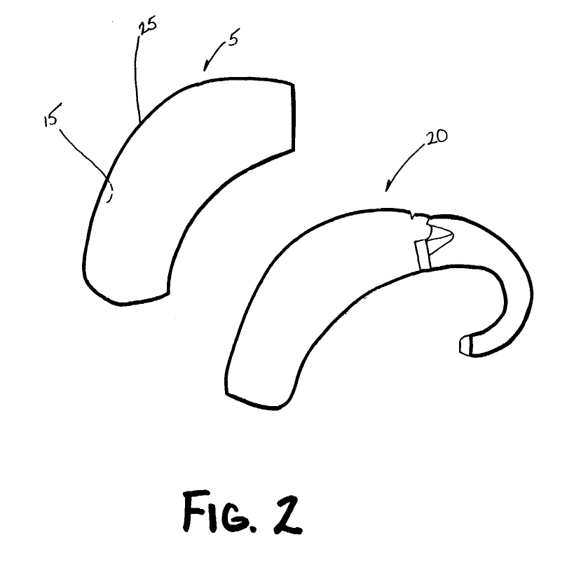

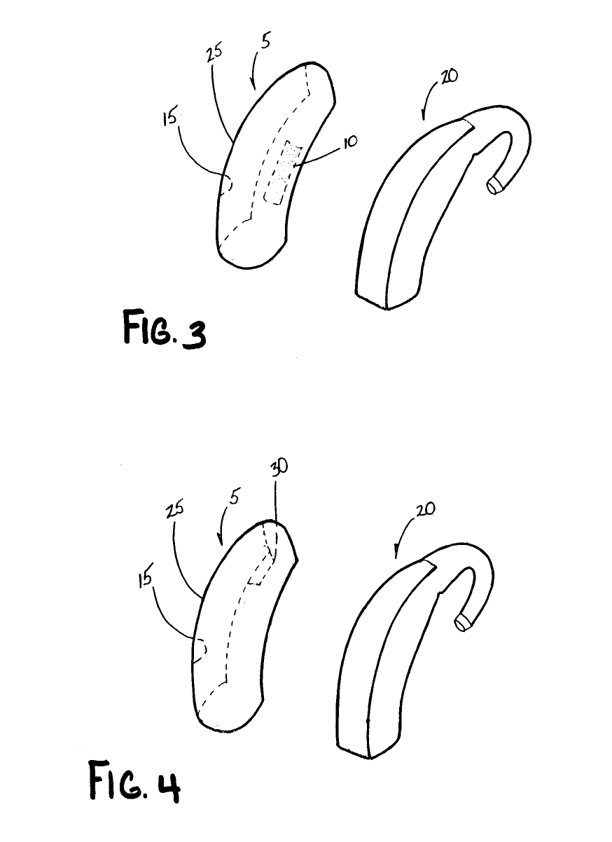

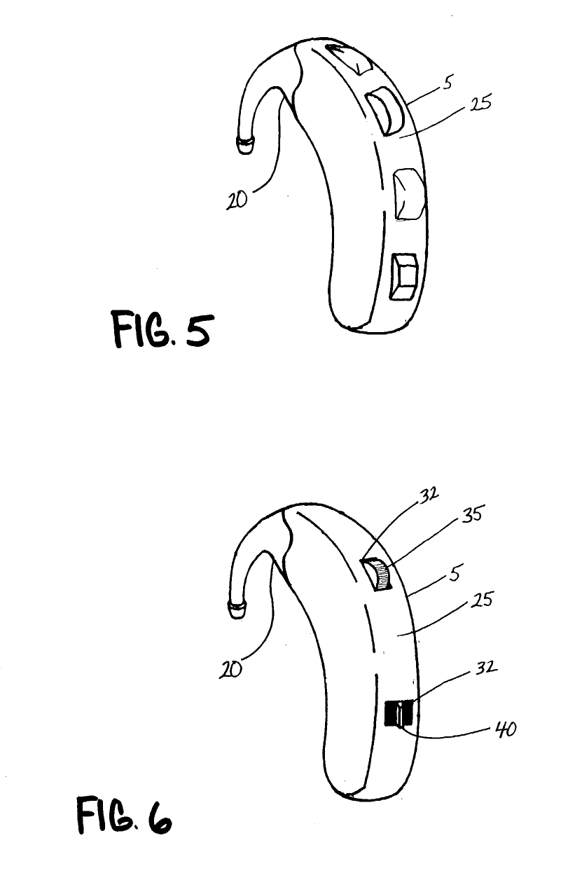

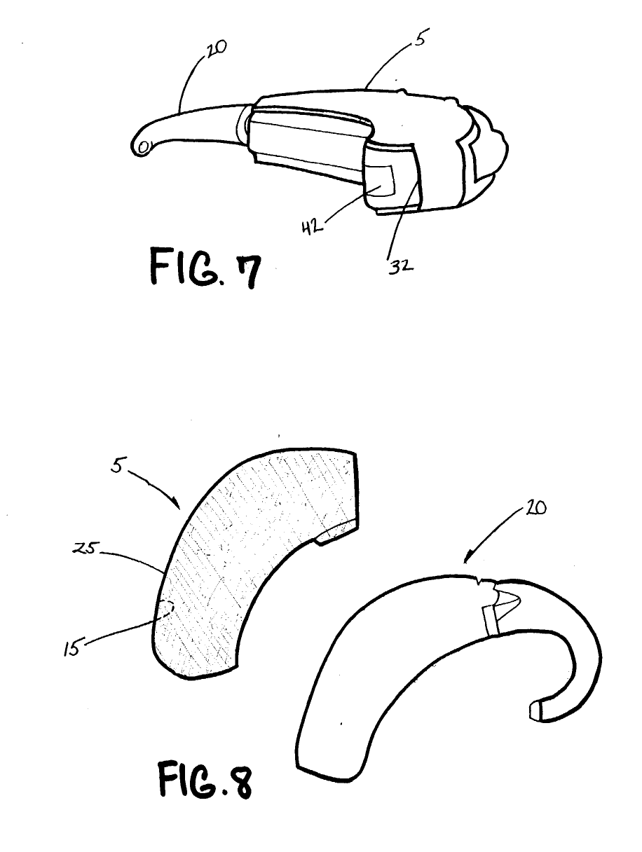

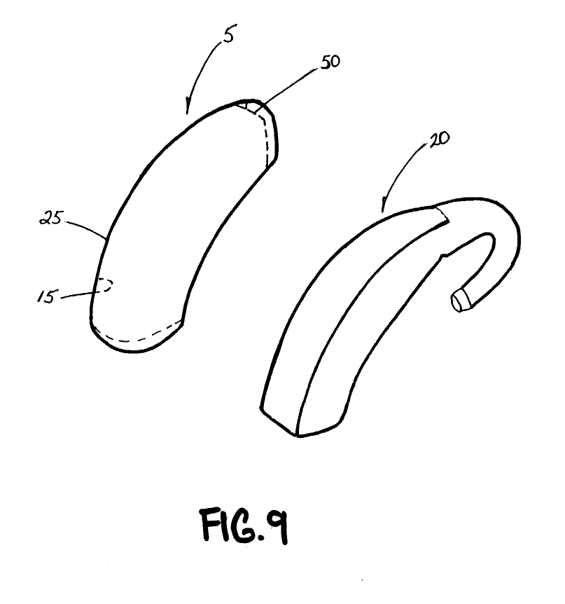

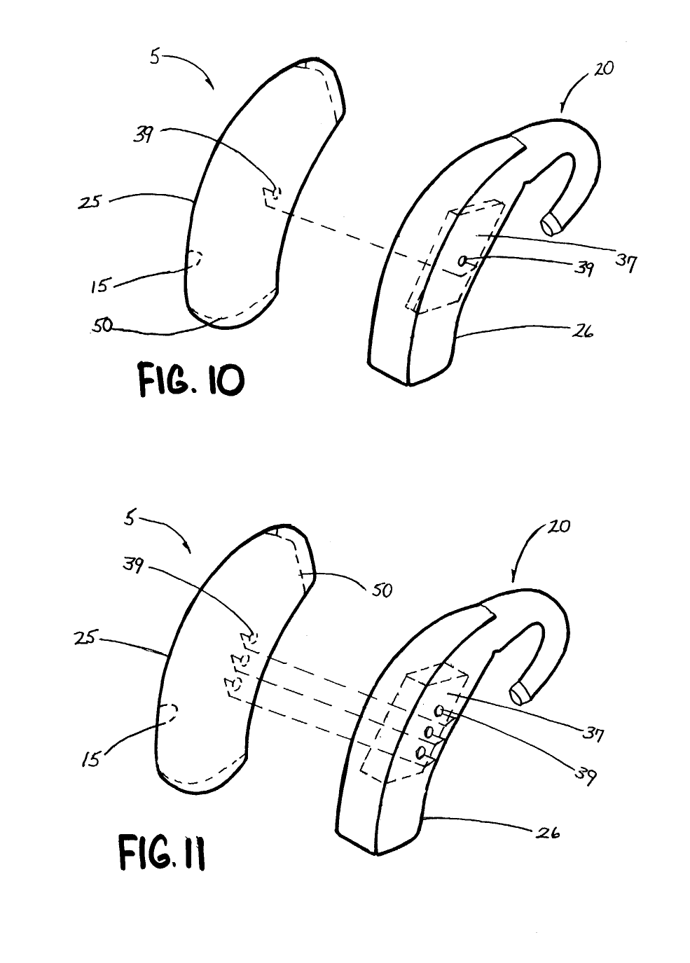

FIGS. 1 and 2 illustrate one embodiment of a cover 5 and a behind-the-ear (BTE) hearing aid 20 in a non-coupled configuration. The shell 5 is adapted for a removable shaped fit over at least a portion of the hearing aid 20 allowing the user to apply and remove the shell 5 over the hearing aid 20 without the aid of tools. In one embodiment, the shell 5 is shaped to removably fit over at least a portion of the hearing aid 20 without the assistance of a locking mechanism or adhesive. In another embodiment, the shell 5 is shaped to removably fit over at least a portion of the hearing aid 20 with the assistance of an adhesive 10. In yet another embodiment, the shell 5 is shaped to removably fit over at least a portion of the hearing aid 20 with the assistance of one or more snap mechanisms 30. In one embodiment, the shell 5 is also adapted to provide a removable shaped fit over hearing aid 20 accessories. For example, in one embodiment, the shell 5 is adapted to provide a removable shaped fit over direct audio input devices designed to accept direct audio input. For example, the shell 5 is adapted for a removable shaped fit over adapter shoes or boots that connect the hearing aid 20 receiver to, for example, an assistive listening device, television, stereo, or to an external microphone by wire cords.

The cover 5 of the BTE hearing aid 20 includes a shell 5 formed from a rigid material. In one embodiment, the shell includes a smooth rigid material. The rigid material of the shell 5 is adapted to spread about a portion of the hearing aid 20 for a removable shaped fit. In one embodiment, the rigid material of the shell 5 includes a rigid plastic material. In another embodiment, the shell 5 includes a rigid metal material. In another embodiment, the shell 5 includes hybrid laminate constructions. In yet another embodiment, the shell 5 includes metal adapted for magnetic shielding. For example, in one embodiment, the metal adapted for magnetic shielding is MU metal.

FIGS. 3 and 4 illustrate the shell 5 and the BTE hearing aid 20 in a non-coupled configuration. FIG. 3 illustrates one embodiment of the cover 5 of the hearing aid 20 which includes a shell 5 formed from a rigid material removably shaped to fit at least a portion of the hearing aid 20 secured by the adhesive 10. In another embodiment, the rigid material of the shell is adapted to spread about at least a portion of the hearing aid 20 for a removable shaped fit secured by the adhesive 10. In one embodiment, the adhesive 10 is located on a portion of the internal surface 15 of the shell 5. In another embodiment, the shell 5 is secured by an adhesive 10 on at least a portion of the hearing aid 20 itself. In yet another embodiment, the shell 5 is secured by the adhesive 10 on at least a portion of both the shell 5 and the hearing aid 20.

FIG. 4 illustrates another embodiment where the shell 5 is adapted for a removable shaped fit over at least a portion of the behind-the-ear hearing aid 20 by one or more snap mechanisms 30 affixed on one or more ends of the shell 5. In one embodiment, the rigid material of the shell 5 is adapted to spread about a portion of the hearing aid 20 for a removable shaped fit by the one or more snap mechanisms 30.

In one embodiment, the user holds the shell 5 by the external surface 25 of the shell 5 adapted for a removable shaped fit over at least a portion of the BTE hearing aid. The shell 5 is applied to the at least portion of the hearing aid 20 allowing the user to apply and remove the shell 5 over the hearing aid 20 without the aid of tools. The hearing aid 20 together with the shell 5 are subsequently applied about an ear. In another embodiment, the user affixes at least a portion of the BTE hearing aid 20 about the ear. The user holds the shell 5 by the external surface 25 of the shell 5 adapted for a removable shaped fit over at least a portion of the hearing aid 20. The shell 5 is applied to at least a portion of the hearing aid 20 allowing the user to apply and remove the shell 5 over the hearing aid 20 without the aid of tools.

FIG. 5 illustrates one embodiment of the shell 5 coupled with at least a portion of the hearing aid 20 without openings 32 for the components on the external surface 25 of the hearing aid 20. FIGS. 6 and 7 illustrate another embodiment where the shell 5 includes one or more openings 32 incorporated within the shell 5 dimensioned to allow access to one or more components of the behind-the-ear hearing aid 20. In one embodiment, an opening 32 in the shell 5 is dimensioned for access of the volume control 35. In another embodiment, an opening 32 in the shell 5 is dimensioned for access of the switch 40. In yet another embodiment, an opening 32 in the shell 5 is dimensioned for access of the battery door 32. In other embodiments, the openings 32 in the shell 5 are configured for any one or more components of the hearing aid 20.

Radio Frequency (RF) energy and Electromagnetic (EM) energy from the environment may create interference in the hearing aid of the user. For example, when in use a digital wireless phone creates pulsing RF energy around the phone's antenna. The pulsing RF energy generates pulsing direct current from the battery of the phone creating a magnetic field. The magnetic field is picked up by the microphone or telecoil (T-coil) circuitry of the hearing aid causing interference in the form of Radio Frequency Interference (RFI) and/or Electromagnetic Interference (EMI) through the hearing aid 20. Such interferences may make audible sound difficult for the user of the hearing aid 20.

To counter the effects of RFI and EMI, a coating 45 in one embodiment is added to the shell 5 where the coating 45 is adapted to reflect radio frequency energy, electromagnetic energy, or both. FIG. 8 illustrates the shell 5 coated with the coating 45. In one embodiment, the shell 5 is coated with the coating 45 only on the internal surface 15 of the shell 5. In another embodiment, the shell 5 is coated with the coating 45 only on the external surface 25 of the shell 5. In yet another embodiment, the shell 5 is coated with the coating 45 on both the internal surface 15 and the external surface 25 of the shell 5.

To further counter the effects of RFI and EMI, FIG. 9 illustrates one embodiment where the shell 5 incorporates a shield 50 adapted to reflect RF energy, EM energy, or both. In one embodiment, the shield 50 is affixed to the internal surface 15 of the shell 5 by an adhesive. In another embodiment, the shield 50 is affixed to the internal surface 15 of the shell 5 by thermal bonding. In yet another embodiment, the shield 50 is embedded into the shell 5 itself. In one embodiment, the shield 50 includes metal configured to conform to the shape of the shell 5. In one embodiment, the shield 50 includes aluminum configured to conform to the shape of the shell 5. In another embodiment, the shield 50 includes conductive plastic. In another embodiment, the shield 50 includes strategically placed metal adapted for magnetic shielding in direct contact with the shell 5. In yet another embodiment, the shell 5 itself is formed metal strategically adapted for magnetic shielding. For example, in one embodiment the metal adapted for magnetic shielding is MU metal.

In one embodiment, the shield 50 is grounded through one or more circuits 37 in the hearing aid 20. FIGS. 10 and 11 illustrate the shell 5 incorporating a shield 50 adapted to reflect RF energy, EM energy, or both. The shield 50 includes one or more contacts 39 adapted to fit into one or more corresponding contacts 39 on the exterior surface 26 of the hearing aid 20. Each contact 39 affixed to the exterior surface 26 of the hearing aid 20 is connected to one or more designated circuits 37 located inside the hearing aid 20. Each designated circuit 37 inside the hearing aid 20 acts as a ground to channel the non-reflected RF energy, EM energy, or both away from those components in the hearing aid 20 that would pick up the interferences.

FIG. 12 illustrates another embodiment of shielding and grounding RF energy, EM energy, or both from the hearing aid 20. The shield 50 includes a ground tab 52 protruding from the external surface 25 of the cover 5. In one embodiment, the ground tab 52 extends from the shield 50 affixed to the internal surface 15 of the shell 5 through the external surface 25 of the shell 5 at a length. In another embodiment, the ground tab 52 extends from the shield 50 embedded in the shell 5 through the external surface 25 of the shell 5 at a length. The ground tab 52 is adapted to abut the skin about the human ear. The ground tab 52 channels RF energy, EM energy, or both away from the electronics of the hearing aid 20 and through the body of a human which acts as a ground. The ground tab 52 includes a material suitable to channel RF energy, EM energy, or both. In one embodiment, the ground tab 52 includes conductive plastic. In another example, the ground tab 52 includes a substrate. In yet another embodiment, the ground tab 52 includes metal. For example, in one embodiment the ground tab 52 includes aluminum. In another embodiment, the ground tab 52 includes copper. In yet another embodiment, the ground tab 52 includes any precious metal or alloy thereof.

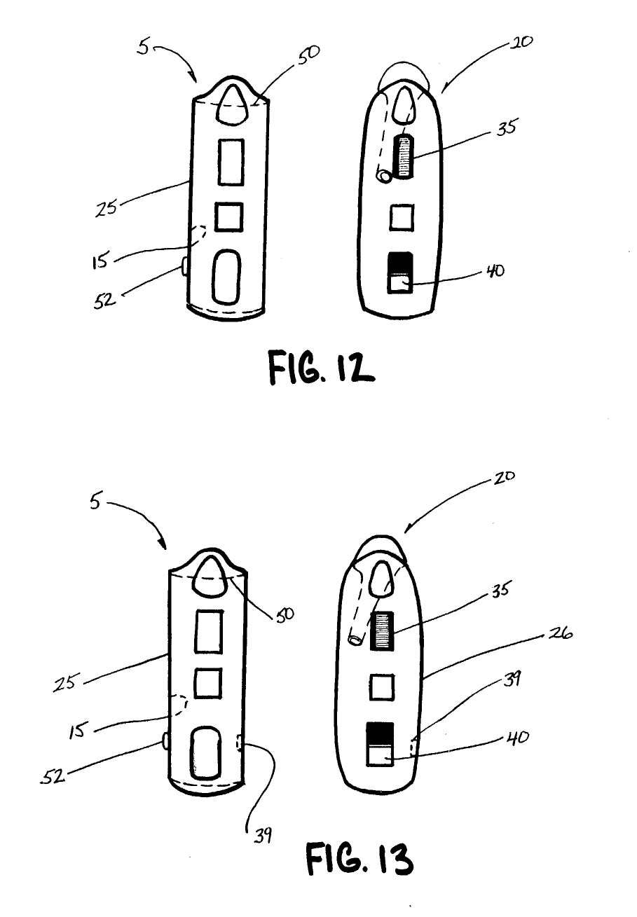

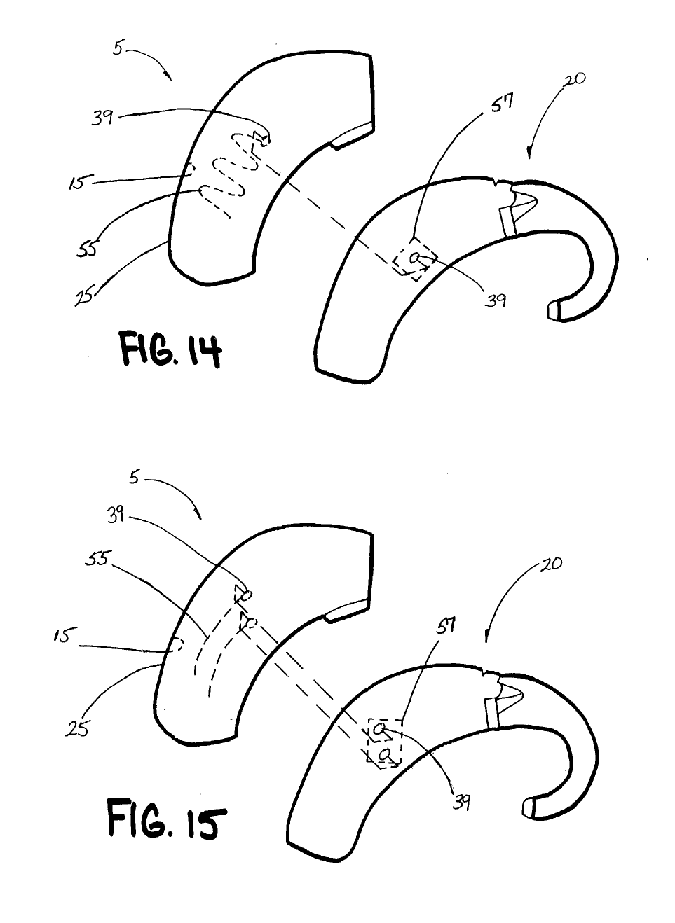

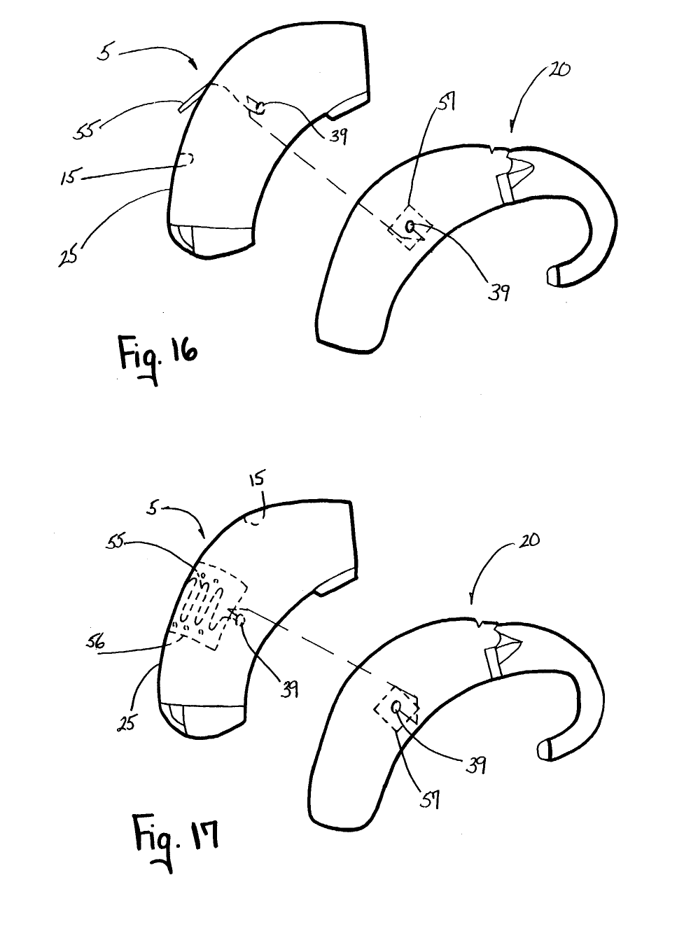

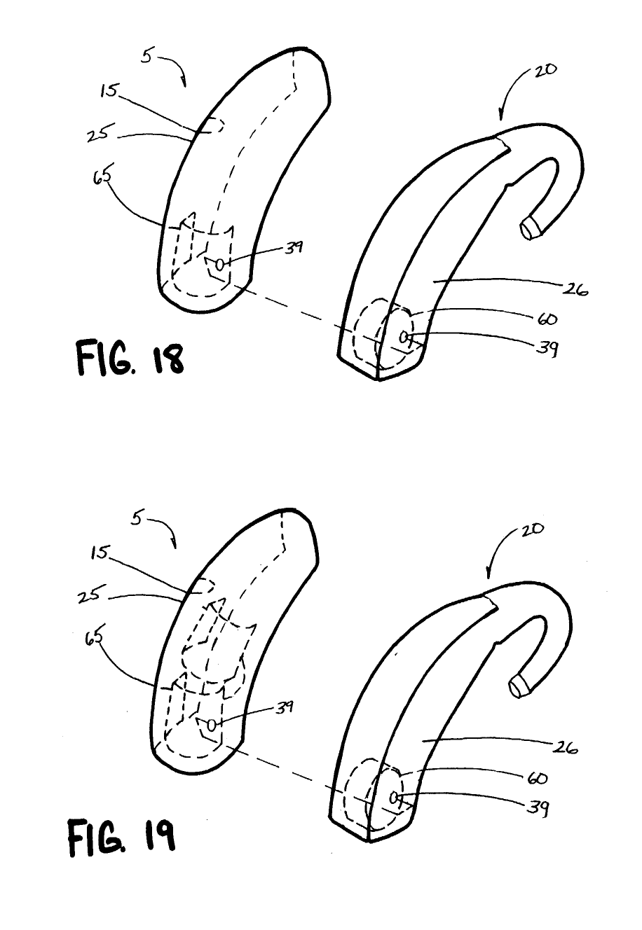

FIG. 13 illustrates another embodiment to shield and ground RF energy, EM energy, or both from the hearing aid 20. The shield 50 includes a ground tab 52 protruding from the external surface 25 of the cover 5. In one embodiment, the ground tab 52 extends from the shield 50 affixed to the internal surface 15 of the shell 5 through the external surface 25 of the shell 5 at a length. In another embodiment, the ground tab 52 extends from the shield 50 embedded in the shell 5 through the external surface 25 of the shell 5 at a length. The ground tab 52 is adapted to abut the skin about the human ear. The ground tab 52 channels RF energy, EM energy, or both away from the electronics of the hearing aid 20 and through the body of a human which acts as a ground. In addition to the ground tab 52 of the shell 5, the shield 50 of the shell 5 includes one or more contacts 39 adapted to couple with one or more contacts 39 incorporated into the hearing aid 20. The one or more contacts 39 affixed to the exterior surface 26 of the hearing aid 20 are connected to one or more selected circuits 37 (See, FIGS. 10 and 11) located inside of the hearing aid 20. Energy not grounded though the user of the hearing aid by the ground tab 52 is grounded through the circuitry of the hearing aid 20.

In another embodiment, interference is eliminated or significantly reduced in the BTE hearing aid 20 by receiving an amount of RF energy, EM energy, or both by one or more antennas. FIG. 14 illustrates one embodiment of the shell 5 with one wire antenna 55 affixed to the shell 5. FIG. 15 illustrates another embodiment of the shell 5 with two wire antennas 55 affixed to the shell 5. In one embodiment, each antenna 55 is affixed to the internal surface 15 of the shell 5 by embedding the wires within the shell 5 itself In another embodiment, each antenna 55 is affixed to the internal surface 15 of the shell 5 by wrapping the wires and attaching the wrap to the inside surface 15 of the shell. In another embodiment, each antenna 55 is affixed to the internal surface 15 of the shell 5 by bonding the wires to the inside surface 15 of the shell 5. In one embodiment, each antenna 55 within the shell 5 includes a contact 39 adapted to fit into a corresponding contact 39 on the exterior surface 26 of the hearing aid 20. Each contact 39 is affixed to the exterior surface 26 of the hearing aid 20 and connected to an amplifier 57 inside the hearing aid 20. The received input signals from the antenna 55 are transmitted to the electrical components of the hearing aid 20 for selective filtering and amplification.

FIG. 16 illustrates another embodiment where the antenna 55 is a protrusion affixed on the exterior surface 25 of the shell 5 and includes a contact 39 adapted to fit into a corresponding contact 39 on the exterior surface 26 of the hearing aid 20. The contact 39 affixed to the exterior surface 26 of the hearing aid 20 is connected to an amplifier 57 inside the hearing aid 20. The received input signals are transmitted to the electrical components of the hearing aid for selective filtering and amplification. This embodiment is also beneficial when used in connection with an FM system. The FM system includes a wireless, portable battery-operated device that uses radio transmission to send auditory signals from a transmitter to a receiver. The FM receiver worn by the user picks up audio signals from the transmitter connected to a microphone. Miniaturized FM receiver units for BTE hearing aid 20 applications are used in FM systems where the miniaturized FM receiver is incorporated into the hearing aid 20 itself. The antenna 55 protrusion incorporated on the exterior surface 25 of the shell 5 illustrates one embodiment of a miniaturized receiving system useful with an FM system.

FIG. 17 illustrates yet another embodiment of the shell 5 with an antenna 55 embedded within a film 56. In one embodiment, the antenna 55 embedded within the film 56 is incorporated into the shell 5 itself. In another embodiment, the antenna 55 embedded within the film 56 is affixed to the internal surface 15 of the shell 5 by bonding the film 56 to the internal surface 15 of the shell 5. The antenna 55 incorporated into the film 56 of the shell 5 includes one or more contacts 39 adapted to fit into one or more corresponding contact 39 on the exterior surface 26 of the hearing aid 20. The one or more contacts 39 affixed to the exterior surface 26 of the hearing aid 20 is connected to the amplifier 57 inside the hearing aid 20 where the received input signals are transmitted to the electrical components of the hearing aid 20 for selective filtering and amplification.

In yet another embodiment, RF and/or EM interference is eliminated or significantly reduced about the hearing aid 20 by generating a magnetic field in an opposing direction of the original RF and/or EM source. FIGS. 18 and 19 illustrate one or more circuits 65 configured in the shell 5 to reflect RF energy, EM energy, or both away from the internal components of the hearing aid 20. The one or more circuits 65 include one or more contacts 39 adapted to fit into one or more corresponding contacts 39 on the exterior surface 26 of the hearing aid 20. The contact 39 affixed to the exterior surface 26 of the hearing aid 20 is connected to a power source. In one embodiment, the power source for the one or more circuits 65 is a battery 60 located inside the hearing aid 20. Each circuit 65 generates a magnetic field that produces a controlled interference of the interfering energy source. In one embodiment, the one or more circuits 50 are embedded within the shell 5 itself. In one embodiment, the one or more circuits 50 are affixed to the internal surface 15 of the shell 5 by bonding the circuits 50 to the inside surface 15 of the shell 5. In another embodiment, the one or more circuits 50 are affixed to the internal surface 15 of the shell 5 by adhesives adapted to adhere the circuits 50 to the inside surface 15 of the shell 5. In another embodiment, the one or more circuits 50 are affixed to the internal surface 15 of the shell 5 by laminating the circuits 50 to the inside surface 15 of the shell 5. In yet another embodiment, the one or more circuits 50 are disposed to a non-metallic shell 5 by electro-chemical plating. For example, in one embodiment, the shell 5 is plastic where the one or more circuits 50 are disposed to the plastic shell 5 by a mask and resist plating process.

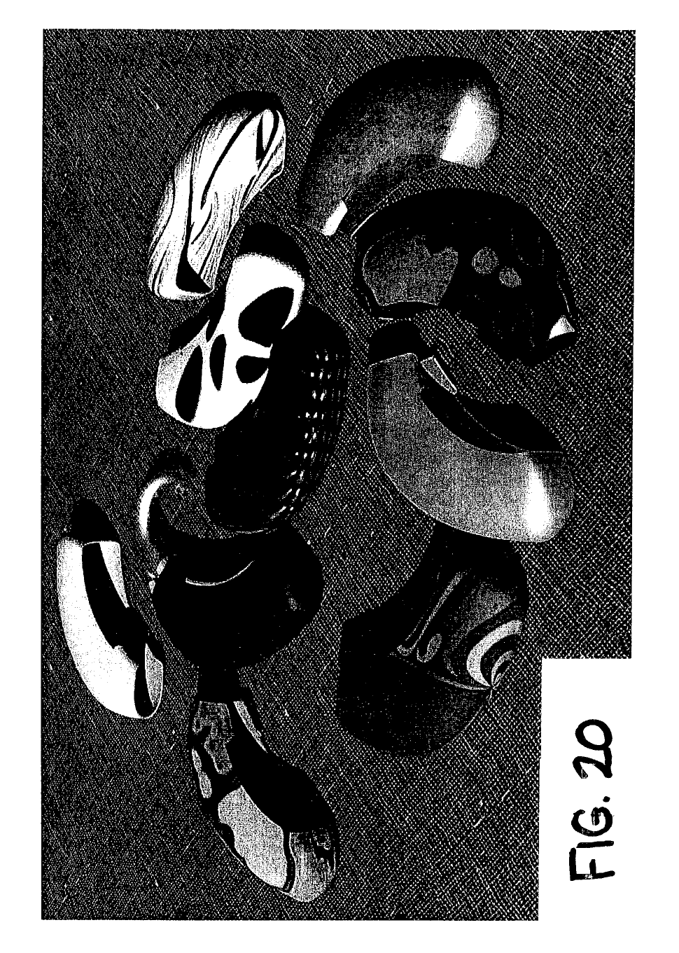

FIG. 20 illustrates selected embodiments of the external surface 25 of individual shells 5 that include decorations. In one embodiment, the decorations provide cosmetic enhancements. In another embodiment, the decorations provide both cosmetic and functional enhancements. In one embodiment, the decorations function, at least in part, as the reflective coating 45 of the hearing aid 20.

A method of manufacturing the invention includes forming a shell 5 from a rigid material, the shell 5 adapted for a removable shaped fit over at least a portion of the BTE hearing aid 20. The manufacture of the formed shell 5 for the hearing aid 20 and any hearing aid accessories include, but is not limited to, the processes of injection molding, pressure forming, vacuum forming and bulge or draw metal forming. In one embodiment, the shell 5 is formed with a smooth finish. Examples of hearing aid accessories include, but are not limited to, shoes and/or boots for the hearing aid 20. In one embodiment, secondary post form trim processes which affect the final shape of the shell 5 or which prepares the shell 5 for downstream treatment of its shape is utilized. These processes include, but are not limited to manual trimming of the shell 5 with common or custom tools. Examples of common or custom tools include, but are not limited to files, cutters, sandpaper, CNC router trimming, and laser cutting and stage tooled trim dies for specific shapes or perforation of the shell 5.

In one embodiment, the openings 32 of the various shapes for the external components of the hearing aid 20 are created within the shell 5 as needed to allow access to one or more components of hearing aid 20. For example, the openings include, but are not limited to, an access hole for the volume control 35, battery door 42, or for a microphone port. In one embodiment, the openings 32 are created by one or more of the primary processes described above. In another embodiment, the openings 32 are created by one or more of the secondary processes described above. Further, the shape of the removable shaped fit of the shell 5 is created by any one or more of the primary and secondary processes described above allowing the user to apply and remove the shell 5 over the hearing aid 20 without the aid of tools.

In another embodiment, the shell 5 is formed by one or more of the above processes to include a rigid material adapted to spread about a portion of the hearing aid 20 for a removable shaped fit. In yet another embodiment, the rigid material of the shell 5 formed by one or more of the above processes is adapted to spread about a portion of the hearing aid 20 for a removable shaped fit by one or more snap mechanisms 30 incorporated into the shell 5.

In one embodiment, one or more components are included in the manufacture of the shell 5. Components include, but are not limited to, a shield 50, one or more antennas 55, one or more circuits 65, or a combination thereof adapted to reflect and/or channel RF energy, EM energy, or both.

In one embodiment, the shell 5 is includes metal plating formed by an electro-chemical plating process. For example, in one embodiment, the shell 5 is formed from plastic where electrochemical plating is disposed to the plastic shell 5 by a mask and resist plating process. The electrochemical plating is capable of reflecting RF energy and EM energy. In another embodiment, the one or more circuits 50 are deposed to a non-metallic shell 5 by an electro-chemical plating process. In yet another embodiment, the shell 5 is metalized by a vacuum metalizing process. For example, in one embodiment, the shell 5 includes polycarbonate plastic metalized by a vacuum metalizing process.

In one embodiment, the shell 5 is adhered to the hearing aid 20 by the use of pressure sensitive removable acrylic adhesives placed on the interior surfaces 15 of the shell 5 touching the hearing aid 20 body as needed. In addition, embedding the wires, wrapping the wires, bonding the wires, or a combination thereof, or applying film technologies onto the shell 5 provide additional performance benefits which include blocking or channeling RF energy, EM energy, or both.

In one embodiment, the treatment of the shell 5 occurs by the use of the following processes for the benefit of aesthetic decoration or the application of specialized coatings 45 for functional benefits which include blocking or channeling RF energy, EM energy, or both. These processes include, but are not limited to, air spray coating of paints with decorative materials in various patterns, hand painting, laser marking, thermal transfer printing, in mold decoration, out of mold decorating, and die sublimation coating of the shell 5. These processes further include optional pre and post treatments to benefit adhesion to the substrate and protective coating 45 for reducing abrasion, affecting appearance, affecting performance, or a combination thereof of the shell 5.

In one embodiment, the shell 5 is coated where substrates or surface manipulations to the shell 5 are in direct contact with the human skill. For example, in one embodiment, the coatings are FDA approved barrier coatings that are air sprayed or dip-able.

In one embodiment, the shell 5 is packaged with a paint kit adapted to decorate the shell 5. With the paint kit, the user is able to apply decorations to the shell. In another embodiment, the paint applied by the user to the shell 5 acts as a barrier coating between the shell 5 surface and the human skin.

In one embodiment, electrostatic spray coatings are used to coat the shell 5. Electrostatic spray coatings include, but are not limited to, metal coatings of the shell 5 by one or more of the following processes: a variety of spray, sputter, plating, chemical vapor deposition methods or the application of metal films with adhesive or pressure sensitive adhesive backing.

This description has set forth numerous characteristics and advantages of various embodiments and details of structure and function of various embodiments, but is intended to be illustrative and not intended in an exclusive or exhaustive sense. Changes in detail, material and management of parts, order of process and design may occur without departing from the scope of the appended claims and their legal equivalents.

What is claimed is:

1. A cover for a behind-the-ear hearing aid, comprising:
a shell formed from a rigid material, the shell adapted for a removable shaped fit over at least a portion of the behind-the-ear hearing aid.

2. The cover according to claim 1, wherein the shell further comprises a smooth material.

3. The cover according to claim 1, wherein the rigid material of the shell is adapted to spread about a portion of the behind-the-ear hearing aid for a removable shaped fit.

4. The cover according to claim 1, wherein the shell is adapted for a removable shaped fit over at least a portion of the behind-the-ear hearing aid by one or more snap mechanisms.

5. The cover according to claim 1, wherein the rigid material of the shell is adapted to spread about a portion of the behind-the-ear hearing aid for a removable shaped fit by one or more snap mechanisms.

6. The cover according to claim 1, wherein the shell is adapted for a removable shaped fit over at least a portion of the behind-the-ear hearing aid by an adhesive.

7. The cover according to claim 1, wherein the rigid material of the shell is adapted to spread about a portion of the behind-the-ear hearing aid for a removable shaped fit by an adhesive.

8. The cover according to claim 1, wherein the shell further comprises one or more openings, the one or more openings dimensioned to allow access to one or more components of the behind-the-ear hearing aid.

9. The cover according to claim 1, wherein the shell is covered with a coating.

10. The cover according to claim 9, wherein the coating is adapted to reflect radio frequency energy, electromagnetic energy, or both.

11. The cover according to claim 1, wherein the shell further comprises one or more antennas.

12. The cover according to claim 1 wherein the shell further comprises one or more circuits adapted to reflect radio frequency energy, electromagnetic energy, or both.

13. The cover according to claim 1, wherein the shell further comprises decorations.

14. The cover according to claim 1, wherein the shell incorporates a shield adapted to reflect radio frequency energy, electromagnetic energy, or both.

15. The cover according to claim 14 wherein the shield is grounded through one or more circuits in the behind-the-ear hearing aid.

16. The cover according to claim 14 wherein the shield is grounded through the human body.

17. A method of manufacturing a cover for a behind-the-ear hearing aid, comprising:
forming a shell having a rigid material, the shell adapted for a removable shaped fit over at least a portion of the behind-the-ear hearing aid.

18. The method according to claim 17, wherein forming the shell includes forming the shell with a smooth material.

19. The method according to claim 17, wherein forming the rigid material of the shell includes forming a material adapted to spread about a portion of the behind-the-ear hearing aid for a removable shaped fit.

20. The method according to claim 17, wherein forming the shell includes forming one or more snap mechanisms adapted for a removable shaped fit over at least a portion of the behind-the-ear hearing aid.

21. The method according to claim 17, wherein forming the shell includes applying an adhesive adapted for a removable shaped fit over at least a portion of the behind-the-ear hearing aid.

22. The method according to claim 17, wherein forming the shell includes shaping one or more openings within the shell, the one or more openings dimensioned to allow access to one or more components of the behind-the-ear hearing aid.

23. The method according to claim 17, wherein forming the shell includes applying a coating adapted to reflect radio frequency energy, electromagnetic energy, or both.

24. The method according to claim 17 wherein forming the shell includes incorporating a shield adapted to reflect radio frequency energy, electromagnetic energy, or both.

25. The method according to claim 24 wherein forming the shield includes grounding the shield through one or more circuits in the behind-the-ear hearing aid.

26. The method according to claim 24 wherein forming the shield includes grounding the shield through the human body.

27. The method according to claim 17 wherein forming the shell includes incorporating one or more antennas into the shell.

28. The method according to claim 17 wherein forming the shell includes incorporating one or more circuits in the shell adapted to reflect radio frequency energy, electromagnetic energy, or both.

29. The method according to claim 17, wherein forming the shell includes applying decorations onto the shell.

30. A method of using a cover for a behind-the-ear hearing aid, comprising:
holding a shell formed from a rigid material, the shell adapted for a removable shaped fit over at least a portion of the behind the ear hearing aid;
applying the shell adapted for a removable shaped fit over the at least portion of the behind-the-ear hearing aid; and
affixing at least a portion of the behind-the-ear hearing aid and the shell about an ear.

31. The method according to claim 30, wherein applying the shell adapted for a removable shaped fit over the at least portion of the behind-the-ear hearing aid includes applying the shell comprising a smooth material.

32. The method according to claim 30, wherein applying the shell includes applying the shell with one or more openings, the one or more openings dimensioned to allow access to one or more components of the behind-the-ear hearing aid.

33. The method according to claim 30, wherein applying the shell includes applying a shell with decorations in direct contact with the shell.
